(19) United States
(12) Patent Application Publication
(10) Pub. No.: US 2016/0186475 A1
(43) Pub. Date: Jun. 30, 2016

(54) HINGE ATTACHMENT FOR CONVENIENT INSTALLATION AND ENHANCED FUNCTIONALITY

(71) Applicant: Hercy J. Moore, Austell, GA (US)

(72) Inventor: Hercy J. Moore, Austell, GA (US)

(21) Appl. No.: 14/986,319

(22) Filed: Dec. 31, 2015

Related U.S. Application Data
(60) Provisional application No. 62/099,056, filed on Dec. 31, 2014.

(51) Int. Cl. E05D 11/06

(52) U.S. Cl. CPC E05D 11/06

(57) ABSTRACT

A hinge attachment including a curved body including a first end and a second end at opposite ends of a length of the curved body defining an opening into a passage enclosed by an inner surface of the curved body, the inner surface adapted to fit around a knuckle of a hinge, the opening is wider than a thickness of a hinge plate attached to the knuckle, a pass-through wall section of the curved body that includes a first thickness that is less than a size of a gap between the knuckle and an opposing hinge plate of the hinge, and a function-enhancing section along the length of the curved body including a stop portion defined by a second thickness greater than the first thickness, wherein the second thickness is greater than the size of the gap between the knuckle and the opposing hinge plate of the hinge.

### CROSS-REFERENCE TO RELATED APPLICATIONS

This application incorporates by reference and claims the benefit of priority to U.S. Provisional Patent Application No. 62/099,056 filed Dec. 31, 2014.

### BACKGROUND OF THE INVENTION

The present subject matter relates generally to a door hinge attachment for convenient installation and enhanced functionality. More specifically, the present invention relates to a door hinge attachment that acts as a stop to limit the full range of door motion.

Hinge attachments are often sold in home improvement, hardware, housewares, and other retail stores. Such attachments provide at least one form of additional functionality that the hinge doesn't provide in and of itself. The form of additional functionality could include the ability to stop the hinge from rotating beyond a certain point, the ability to hang something from the hinge, for example a towel, or some other functionality. In order to provide the benefit of additional functionality, hinge attachments must be connected to a hinge, and the connection must be securely maintained. Unfortunately, previous hinge attachments on the market tend to be inconvenient to install and to have connections that loosen over time.

Hinge attachments are inconvenient to install because installation requires removing the hinge pin from the hinge, positioning the hinge attachment, and reengaging the hinge pin within the hinge attachment and the hinge, thus connecting the two. A user cannot remove a properly set hinge pin by hand. Consequently, the user must utilize additional tools to remove the hinge pin and install the hinge-pin mounted hinge attachment. This inconvenient method of installation means that it's equally inconvenient to uninstall the hinge-pin mounted hinge attachment.

When the hinge attachment is mounted and the hinge is closed, friction is generated between the hinge, hinge attachment, and hinge pin. Over time, this friction works to loosen the connection between hinge pin, hinge attachment, and hinge. As a result of this, a user must periodically reset the hinge pin tight against the hinge attachment and hinge. In essence, maintenance activity is required to ensure that the connection between hinge attachment and hinge is securely maintained.

U.S. Pat. No. 3,602,942 A to Miller and Neff (hereinafter, the '942 patent) discloses a hinge attachment in the form of a hinge stop that is a flexible C-shaped resilient clip. The clip can be attached without removing a hinge pin. The clip is made of flexible resilient sheet material and is slipped into place over the knuckle of the hinge.

The clip of the '942 patent may include flat flanges that straddle both sides of one hinge plate. One of the flanges is sandwiched between the hinge plates when they are closed tight against one another. The goal is to provide a reasonably resilient hinge stop. However, a hinge stop needs to be rigid in order to withstand the force of hinged objects swinging radially and to actually stop hinge rotation. The flexibility inherent in the resilient clip limits its ability to stop hinge rotation. The flexibility also reduces the clip's ability to maintain a secure connection to the hinge. To compensate for the lack of rigidity in the clip, the '942 patent teaches using a separate coiled collar or split ring to stabilize the clip.

The flat flange that is sandwiched between the hinge plates is another problem with the '942 patent. The flange could prevent the hinge from closing as flush as it should for normal operation.

In conclusion, no hinge attachment formerly developed provides additional functionality in one design, while also providing: a) convenient installation without removing the hinge pin and without requiring the use of additional tools and b) effectiveness that is not diminished or negatively compromised by the loosening of the connection to the hinge with use.

Accordingly, there is a need for a hinge attachment, as described herein.

### BRIEF SUMMARY OF THE INVENTION

To meet the needs described above and others, the present disclosure provides a hinge attachment that acts as a stop to limit the full range of door motion. In an example embodiment, a hinge attachment may include an enclosing member that attaches to a knuckle of a hinge and mounts without removing the hinge pin of the hinge. The enclosing member may include a pass-through wall section that allows the hinge to rotate freely while the hinge attachment is mounted on the hinge. In an embodiment, the enclosing member is not a completely enclosed circle, but may include an opening that facilitates straddling a hinge plate while the hinge attachment is mounted on the hinge. A function-enhancing portion may extend from the enclosing member to provide functionality that the hinge doesn't provide alone. The function-enhancing portion may be shaped, sized, and disposed to provide functionality that the hinge doesn't provide in and of itself.

In an example embodiment, the hinge attachment may be rigid and may be made of lightweight metal such as carbon steel, stainless steel, aluminum, alloys thereof or other material of sufficient strength, durability, and resiliency to withstand the rotational forces associated with the opening and closing of a hinge.

In an embodiment, a hinge attachment includes a curved body including a first end and a second end at opposite ends of a length of the curved body defining an opening into a passage enclosed by an inner surface of the curved body, the inner surface adapted to fit around a knuckle of a hinge, the opening is wider than a thickness of a hinge plate attached to the knuckle, a pass-through wall section of the curved body that includes a first thickness that is less than a size of a gap between the knuckle and an opposing hinge plate of the hinge, and a function-enhancing section along the length of the curved body including a stop portion defined by a second thickness greater than the first thickness, wherein the second thickness is greater than the size of the gap between the knuckle and the opposing hinge plate of the hinge.

In some embodiments, when the hinge attachment is affixed to a hinge, the hinge plate may move freely along the length of the curved body from the first end to the stop portion. And, in some embodiments, the stop portion limits the range of travel of the opposing hinge plate to ninety degrees. Additionally, in some embodiments, the stop portion limits the range of travel of the opposing hinge plate to forty-five degrees.

Moreover, in some embodiments, the stop portion limits the range of travel of the opposing hinge plate to an amount between thirty to sixty degrees. Also, in some embodiments, the stop portion limits the range of travel of the opposing hinge plate to an amount between seventy-five to ninety degrees. Further, in some embodiments, the stop portion limits the range of travel of the opposing hinge plate to an amount between one hundred twenty to one hundred fifty degrees. Even further, in some embodiments, the curved body is a unitary body.

In an embodiment, a method of adding functionality to a hinge, includes the steps of: providing a hinge attachment comprising a curved body including: a first end and a second end at opposite ends of a length of the curved body defining an opening into a passage enclosed by an inner surface of the curved body, the inner surface adapted to fit around a knuckle of a hinge, the opening is wider than a thickness of a hinge plate attached to the knuckle, a pass-through wall section of the curved body that includes a first thickness that is less than a size of a gap between the knuckle and an opposing hinge plate of the hinge, and a function-enhancing section along the length of the curved body including a stop portion defined by a second thickness greater than the first thickness, wherein the second thickness is greater than the size of the gap between the knuckle and the opposing hinge plate of the hinge, and mounting the hinge attachment to the hinge by aligning the opening with the hinge plate and sliding the hinge attachment over the knuckle; wherein, when the hinge attachment is mounted on the hinge, the stop portion limits the range of travel of the opposing hinge plate to an open angle.

In some embodiments, the open angle is one hundred eighty degrees. In other embodiments, the open angle is ninety degrees. In further embodiments, the open angle is forty-five degrees.

An advantage of the invention is that it provides an improved hinge attachment that provides functionality that the hinge doesn't provide.

Another advantage of the invention is that it provides a more user-friendly mounting of the hinge attachment by enabling mounting without removing the hinge pin and without the use of other tools.

A further advantage of the invention is that it provides a hinge attachment that mounts the hinge forming a connection that remains strong over time without requiring periodic adjustment to the connection.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example embodiment of a hinge attachment.

FIG. 2A is a top view of the hinge attachment of FIG. 1.

FIG. 2B is a bottom view of the hinge attachment of FIG. 1.

FIG. 3 is another perspective view of the hinge attachment of FIG. 1.

FIG. 4A is a perspective view of a hinge.

FIG. 4B shows an example embodiment of a hinge attachment mounted on a hinge that is substantially closed.

FIG. 4C is a view similar to FIG. 4B, but showing the hinge open.

FIG. 5A is a perspective view of an example embodiment of a hinge attachment.

FIG. 5B shows the example embodiment of the hinge attachment in FIG. 5A mounted on a hinge that is opened at a wider angle than the hinge in FIG. 4C.

FIG. 6 shows a top view of an example embodiment of a hinge attachment.

The accompanying drawings are provided to assist in the understanding of the exemplary embodiments of the hinge attachment as described in more detail below and should not be construed as unduly limiting the hinge attachment. In particular, the relative spacing, positioning, sizing, and dimensions of the various elements illustrated in the drawings are not necessarily drawn to scale and may have been exaggerated, reduced, or otherwise modified for the purpose of improved understanding and clarity.

Those of ordinary skill in the art will appreciate that a range of alternative configurations have been omitted simply to improve the clarity and reduce the number of drawings. Those of ordinary skill will also appreciate that certain of the various process steps illustrated or described with respect to the exemplary embodiments may be selectively and independently combined to create other methods useful for designing, manufacturing, and/or using a hinge attachment without departing from the scope and spirit of this disclosure. Referring now to the drawings in which like reference numerals designate like or corresponding parts throughout the several views, there is shown example embodiments of a hinge attachment, shown for the purpose of illustration. One skilled in the art will readily recognize from the following descriptions, taken in conjunction with the accompanying drawings and claims, that the principles of the subject matter of the present application may be applicable to other embodiments other than that shown for purposes of illustration in the drawings.

### DETAILED DESCRIPTION OF THE INVENTION

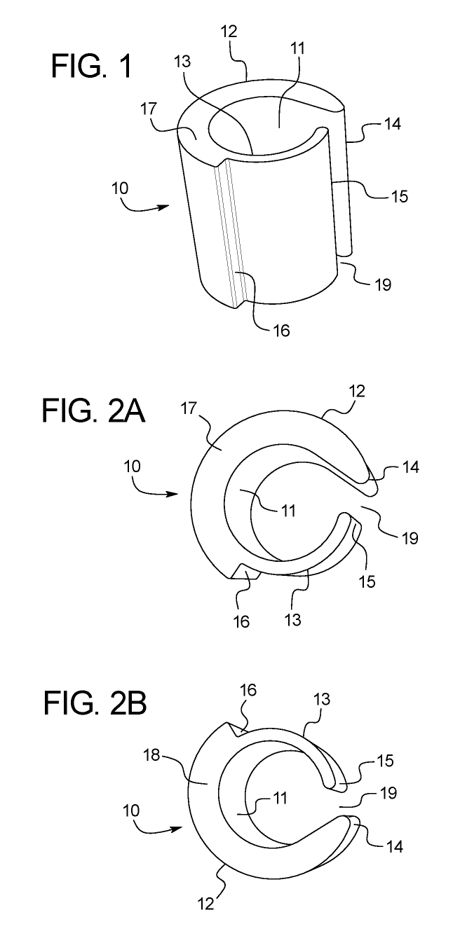

FIG. 1 is a perspective view of an example embodiment of a hinge attachment 10. Hinge attachment 10 may include an enclosing member 11, which is of a predetermined shape and is curved inward. The inner surface of enclosing member 11 may be similar to the inner surface of an inner tube or cylindrical pipe. However, unlike a cylindrical pipe, the curvature of enclosing member 11 may stop short of being a completely enclosed cylinder and, in an embodiment, is not continuous. The enclosing member 11 ends in enclosing member edges 14 and 15.

An opening 19 may include the space that separates enclosing member edges 14 and 15. Edges 14 and 15 may be located at opposite ends of a length of the curved body of the hinge attachment 10. For example, edge 15 may be located at a first end, and edge 14 may be located at a second end. The edges 14 and 15 may define an opening 19 into a passage enclosed by an inner surface of the enclosing member 11.

The opening 19 may be of predetermined width. A pass-through wall section 13 begins from enclosing member edge 15 on one side of opening 19 and may end at a predetermined disposition along the outer curved surface of enclosing member 11. The pass-through wall section 13 may be an integrally formed portion of the enclosing member 11.

A function-enhancing portion 12 may extend from and may be integrally formed with the enclosing member 11. The function-enhancing portion 12 may include a predetermined shape, predetermined size, and predetermined disposition. The function-enhancing portion 12 may begin where pass-through wall section 13 ends along the outer curved surface of enclosing member 11. In an embodiment, the function-enhancing portion 12 and the pass-through wall section 13 may connect seamlessly at integral connection 16 along the outer curved surface of enclosing member 11.

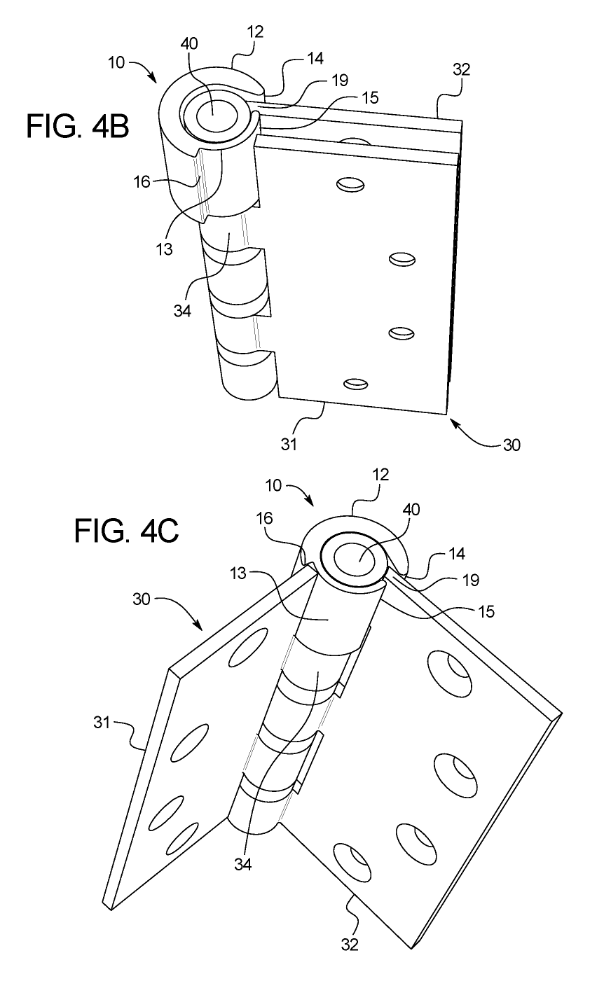

The integral connection 16 may act as a stop portion to limit the range of motion of a hinge 30 (FIG. 4A). The integral connection 16 may be defined by the transition from a first thickness of the pass-through wall section 13 to a second thickness of the function-enhancing portion 12. The function-enhancing portion 12 may extend from integral connection 16 to enclosing member edge 14.

As shown, in an embodiment, a hinge attachment 10 is a curved body. And, as shown, in an embodiment, the curved body is a unitary body where all of the elements are integrally formed.

FIG. 2A is a top view of hinge attachment 10, showing the seamless connection between function-enhancing portion 12 and pass-through wall section 13. FIG. 2A also shows end plain 17, which, depending on the hinge attachment's orientation, could be deemed either the top or bottom of the hinge attachment. Opening 19 is in the space between enclosing member edges 14 and 15.

FIG. 2B is a bottom view of hinge attachment 10, showing the seamless connection between function-enhancing portion 12 and pass-through wall section 13. FIG. 2B shows end plain 18, which is the mirror opposite of end plain 17 and, depending on the hinge attachment's orientation, could be deemed the top or the bottom of the hinge 30. Opening 19 is in the space between enclosing member edges 14 and 15. In some embodiments, the end plain 17 or the end plain 18 may enclose one end of the passageway defined by the inner surface of the enclosing member. Additionally, in some embodiments, the end plain 17 or the end plain 18 may include a portion that encloses a portion of the passageway, such as a portion that encloses the mid-span of the passageway.

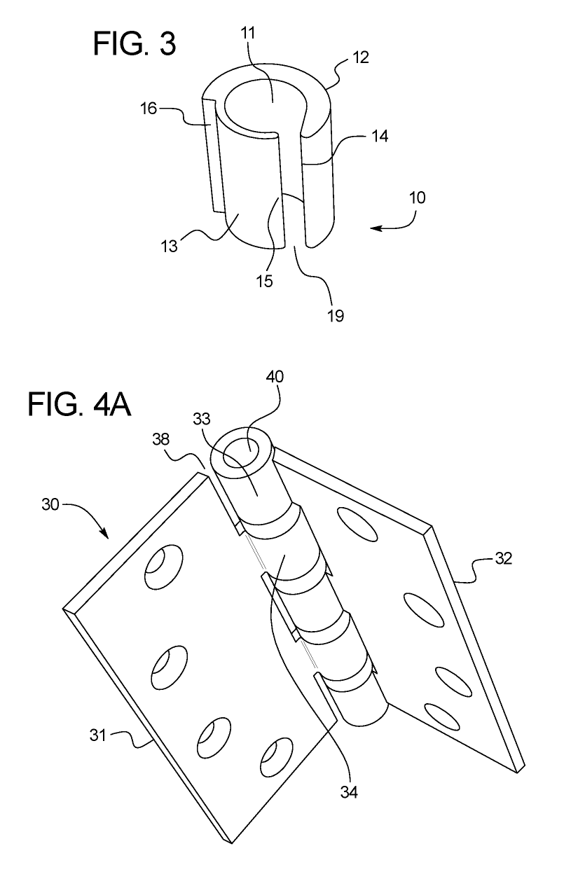

FIG. 3 is a perspective view of hinge attachment 10 similar to FIG. 1. The perspective view of FIG. 3 more clearly shows opening 19 between enclosing member edges 14 and 15.

FIG. 4A is a perspective view of a hinge 30. The hinge 30 may include an opposing hinge plate 31 and primary hinge plate 32. The primary hinge plate 32 is integrally attached to knuckle 33, as well as other knuckles in the center and at the bottom of primary hinge plate 32. The opposing hinge plate 31 is integrally attached to knuckle 34, as well as another knuckle. The knuckles of opposing hinge plate 31 and primary hinge plate 32 are aligned and connected by hinge pin 40. The knuckles and hinge plates move radially around hinge pin 40. There is a gap 38 between opposing hinge plate 31 and knuckle 33.

FIGS. 4B and 4C show an example embodiment of hinge attachment 10 mounted on hinge 30. In FIG. 4B the hinge 30 is substantially closed. The diameter of enclosing member 11 may be slightly larger than knuckle 33 so that enclosing member 11 can slide over and encompass knuckle 33. The pass-through wall section 13 may be slightly thinner than gap 38 so that pass-through wall section 13 may rest within gap 38 when hinge attachment 10 is mounted on hinge 30. The opening 19 may be slightly wider than the thickness of primary hinge plate 32 so that primary hinge plate 32 may rest inside opening 19 when hinge attachment 10 is mounted on hinge 30. Knuckle 34 may be connected to opposing hinge plate 31. While mounted, the hinge attachment 10 may rest on the connection between knuckle 34 and opposing hinge plate 31. As shown, the thickness of the integral connection 16 is greater than the size of the gap between the knuckle and the opposing hinge plate of the hinge.

FIG. 4C shows an example embodiment of hinge attachment 10 mounted on hinge 30. In FIG. 4C, hinge 30 is fully open. Hinge attachment 10 may be mounted on hinge 30 in the same way that it is mounted on hinge 30 in FIG. 4B. In FIG. 4C, the hinge 30 is rotated fully open because the opposing hinge plate 31 is engaged with the integral connection 16. The integral connection 16 may be thicker than gap 38 such that integral connection 16 cannot fit between gap 38 thus limiting the range of motion of the opposing hinge plate 31.

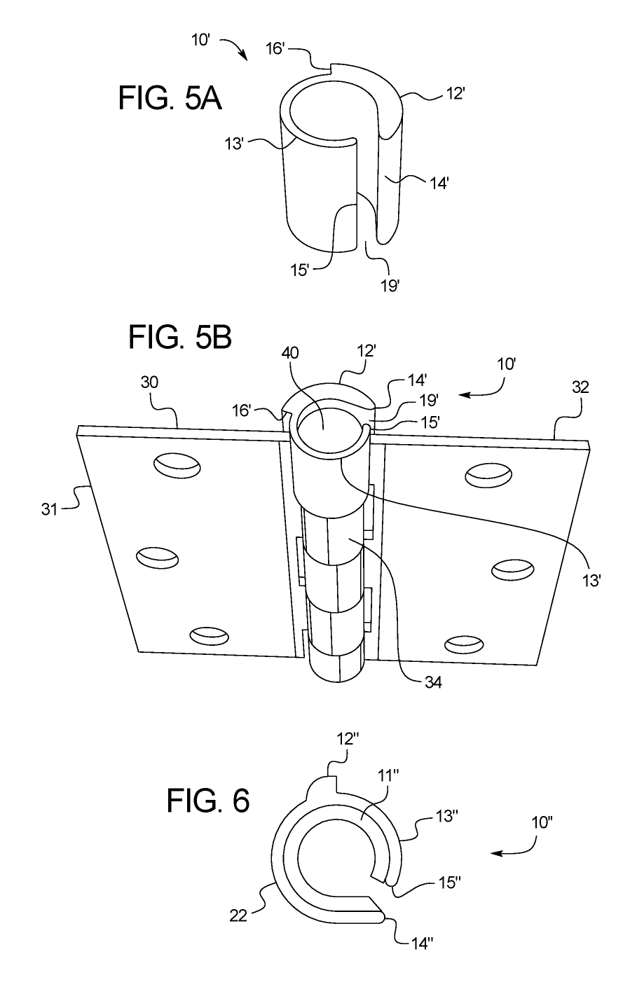

The example embodiment of hinge attachment 10′ of FIGS. 5A and 5B differs from the embodiment in FIG. 1 because the arc length of pass-through wall section 13′ is longer than that of pass-through wall section 13. Also, as shown, the arc length of function-enhancing portion 12′ may be shorter than that of function-enhancing portion 12. Along the arc length of function enhancing portion 12′, integral connection 16′ may be closer to enclosing member edge 14′ than integral connection 16 is to enclosing member edge 14.

FIG. 5B shows an embodiment of the hinge attachment 10′ mounted on hinge 30. The mounting is similar to that of FIGS. 4A and 4B. However, in FIG. 5B, hinge 30 is open to a wider angle than hinge 30 in FIG. 4B. The open angle between opposing hinge plate 31 and primary hinge plate 32 may be wider because integral connection 16′ engages opposing hinge plate 31 at a point that allows for a wider open angle.

In some embodiments, the open angle may be ninety degrees. In other embodiments, the open angle may be one hundred eighty degrees. In further embodiments, the open angle may be forty-five degrees. It is contemplated that the hinge attachment 10 and 10′ may be formed to include an open angle of any degree useful to consumers as will be appreciated by those of skill in the art from the examples provided herein.

Moreover, in some embodiments, the open angle may be an amount between thirty to sixty degrees. Also, in some embodiments, the open angle may be an amount between seventy-five to ninety degrees. Further, in some embodiments, the open angle may be an amount between one hundred twenty to one hundred fifty degrees.

### Operation

### FIGS. 1, 2A, 2B, 3, 4A, 4B, 4C, 5A, 5B

In operation, one uses hinge attachment 10 by properly aligning it above the knuckle 33 of hinge 30 and sliding it over knuckle 33.

To properly align hinge attachment 10 above knuckle 33, the user fully closes hinge 30. The user then positions hinge attachment 10 over knuckle 33 so that enclosing member 11 aligns with the outer curved edge of knuckle 33. The user also orients hinge attachment 10 so that pass-through wall section 13 is directly above gap 38. The user makes sure that no part of function-enhancing portion 12 is directly above gap 38. Opening 19 must be aligned directly over primary hinge plate 32. Once properly aligned in accordance with the above paragraph, the user mounts hinge attachment 10 by sliding it down and over knuckle 33 so that knuckle 33 is enclosed in enclosing member 11. When hinge attachment 10 is mounted, knuckle 33 is substantially hidden from the user's view.

As shown in FIGS. 4B and 4C, when hinge attachment 10 is mounted, the hinge plate 32 may fit within opening 19 and is engaged on one side by enclosing member edge 14 and on the other side by enclosing member edge 15. Enclosing member edges 14 and 15 may prevent hinge attachment 10 from rotating around knuckle 33.

Since pass-through wall section 13 is thinner than gap 38, hinge plates 31 and 32 still freely rotate around hinge pin 40. The free rotation of hinge plates 31 and 32 is stopped when hinge 30 is opened wide enough so that opposing hinge plate 31 impacts the integral connection 16. The function-enhancing portion 12 of hinge attachment 10 provides additional functionality to stop the rotation of hinge 30 without damaging or impacting any objects attached to hinge 30 because function-enhancing portion 12 may be sized, shaped, and located to impact only opposing hinge plate 31 and not objects attached to hinge 30. The location of integral connection 16 and the shape of function-enhancing portion 12 may govern how wide or narrow hinge 30 can open before impacting function-enhancing portion 12. The angle of free rotation may increase as the arc length of pass-through wall section 13 increases and integral connection 16 moves circumferentially farther away from enclosing member edge 15.

It will be apparent that the arc lengths of the pass-through wall section 13 and function enhancing portion 12 may be changed and adjusted to produce multiple embodiments of a hinge attachment. It will also be apparent that the size, shape, and location of function enhancing portion 12 can be changed and adjusted to produce multiple embodiments of a hinge attachment. Each embodiment may affect: 1) how wide the hinge could open and 2) what additional functionality would be provided by the hinge attachment.

Another embodiment of a hinge attachment is shown in FIG. 5A. In FIG. 5B, the hinge attachment of FIG. 5A is mounted on hinge 30. Function-enhancing portion 12′ provides additional functionality to stop the rotation of hinge 30. However, since the arc length of pass-through wall section 13′ is longer than the arc length of pass-through wall section 13, when the hinge attachment of FIG. 5A is mounted on hinge 30, hinge 30 opens to a wider angle before it's rotation is stopped by function-enhancing portion 12′ than hinge 30 opens when hinge attachment 10 is mounted on hinge 30.

The hinge attachment 10 may be removed from hinge 30 by closing hinge 30 to a point where opposing hinge plate 31 is not impacting function-enhancing portion 12. By doing this, the user may reduce tension and friction between hinge 30 and hinge attachment 10. After reducing friction and tension in this way, the user can grip hinge attachment 10 and easily slide it up and off knuckle 33, thus dismounting hinge attachment 10 from hinge 30.

In an example embodiment, the hinge attachment 10 may be rigid and may be made of light weight metal such as carbon steel, stainless steel, aluminum, alloys thereof or other material of sufficient strength and resiliency to withstand the rotational forces associated with the opening and closing of a hinge.

In an embodiment, a method of adding functionality to a hinge 30 includes the steps of: providing a hinge attachment 10 comprising a curved body including: a first end including edge 15 and a second end including edge 14 at opposite ends of a length of the curved body defining an opening 19 into a passage enclosed by an inner surface of the curved body of the enclosing member 11, the inner surface adapted to fit around a knuckle 33 of a hinge, the opening 19 is wider than a thickness of a hinge plate 31 attached to the knuckle 33, a pass-through wall section 13 of the curved body that includes a first thickness that is less than a size of a gap 38 between the knuckle 33 and an opposing hinge plate 31 of the hinge, and a function-enhancing section 12 along the length of the curved body including a stop portion defined by a second thickness greater than the first thickness, wherein the second thickness is greater than the size of the gap 38 between the knuckle 33 and the opposing hinge plate 31 of the hinge 30, and mounting the hinge attachment 10 to the hinge 30 by aligning the opening with the hinge plate 32 and sliding the hinge attachment 10 over the knuckle 33; wherein, when the hinge attachment is mounted on the hinge 30, the stop portion limits the range of travel of the opposing hinge plate 31 to an open angle.

The combination of advantages found in hinge attachment 10 is not found in any prior art. The function-enhancing portion 12 is of a predetermined size, predetermined shape, and predetermined disposition to add functionality that the hinge doesn't innately possess. When the example embodiment hinge attachment 10 is mounted to hinge 30, hinge attachment 10 provides functionality to stop the rotation of hinge plates 31 and 32 without impacting and damaging any objects connected to hinge 30.

As shown in the above operation details, hinge attachment 10 may also have an advantage of being truly convenient to mount and dismount. Absolutely no tools are required to mount or dismount hinge attachment 10. No part of hinge 30 needs to be removed in order to mount or dismount hinge attachment 10.

Another advantage of hinge attachment 10 is that the connection between hinge attachment 10 and hinge 30 is not compromised or loosened as hinge 30 is operated and engages hinge attachment 10. The connection remains solid and is maintained for three reasons: (1) enclosing member 11 snugly encompasses a substantial portion of knuckle 33; (2) pass-through wall section 13 fits snug within gap 38; and (3) primary hinge plate 32 is firmly held between enclosing member edges 14 and 15.

### Detailed Description

### FIG. 6

An example embodiment of hinge attachment 10″ shown in FIG. 6 may include enclosing member 11″, which is similar to enclosing member 11 in hinge attachment 10 of FIG. 1. The hinge attachment of FIG. 6 may include pass-through wall section 13″ and wall section 22 which may be integrally attached to the outer surface of enclosing member 11″. Pass-through wall section 13″ may extend to enclosing member edge 15″. Wall section 22 extends to enclosing member edge 14″. The hinge attachment of FIG. 6 also may include function-enhancing portion 12″, which may be integrally attached to the outer surface of enclosing member 11″. Function-enhancing portion 12″ may be integrally attached to the outer surface of enclosing member 11″. Unlike function enhancing portion 12 in hinge attachment 10, in an embodiment, function-enhancing portion 12″ does not extend to enclosing member edge 14″, but is disposed between pass-through wall section 13″ and wall section 22. Function-enhancing portion 12″ may be an appendage that interrupts the smooth transition between pass-through wall section 13″ and wall section 22. The opening 19″ may be formed by the space between enclosing member edges 14″ and 15″.

### Operation

### FIG. 6

In operation, one uses the hinge attachment 10″ of FIG. 6 the same way one uses hinge attachment 10 of FIG. 1. With hinge 30 closed, the user may properly align the hinge attachment 10″ above knuckle 33 of hinge 30 and may slide it down and over knuckle 33.

When the hinge attachment 10″ of FIG. 6 is mounted, primary hinge plate 32 may engage on one side by enclosing member edge 14″ and on the other side by enclosing member edge 15″. Enclosing member edges 14″ and 15″ may prevent the hinge attachment 10″ of FIG. 6 from rotating around knuckle 33.

The free rotation of hinge plates 31 and 32 may be stopped when hinge 30 is opened wide enough so that opposing hinge plate 31 impacts function-enhancing portion 12″. The location of function-enhancing portion 12″ may govern how wide or narrow hinge 30 can open before impacting function-enhancing portion 12″. The function-enhancing portion 12″ provides functionality for stopping the free rotation of hinge 30. The angle of free rotation of hinge plates 31 and 32 increases as the arc length of pass-through wall section 13″ increases and function-enhancing portion 12″ moves circumferentially farther away from enclosing member edge 15″.

The user may remove the hinge attachment 10″ of FIG. 6 similar to how the hinge attachment 10 of FIG. 1 is removed.

It will be apparent that the location of function-enhancing portion 12″ along the arc length of pass-through wall section 13″ may be changed and adjusted to produce multiple embodiments of the hinge attachment 10″. It will also be apparent that the size and shape of function-enhancing portion 12″ may be changed and adjusted to produce multiple embodiments of the hinge attachment 10″ and to govern what type of additional functionality is provided by function-enhancing portion 12″.

Those of ordinary skill in the art will appreciate that a range of alternative configurations have been omitted simply to improve the clarity and reduce the number of drawings. Those of ordinary skill will also appreciate that certain of the various process steps illustrated or described with respect to the exemplary embodiments may be selectively and independently combined to create other methods useful for manufacturing a hinge attachment without departing from the scope and spirit of this disclosure.

All embodiments of the hinge attachment have advantage over prior art because each is truly convenient and easy to mount and dismount. Absolutely no tools are required to mount or dismount the hinge attachment. No part of the hinge needs to be removed to mount or dismount the hinge attachment. The connection remains firm and doesn't require maintenance adjustments. The function-enhancing portion can be sized, shaped, and disposed to provide numerous functions not innately provided by the hinge.

### CONCLUSIONS, RAMIFICATIONS, AND SCOPE

According to one embodiment of the hinge attachment, disclosed herein is an improved hinge attachment that can be easily attached to a hinge without removing the hinge pin and without the use of tools, remains securely attached without the need for periodic maintenance, and provides functionality that the hinge doesn't provide on its own.

While the above description contains much specificity, these should not be construed as limiting the scope of any embodiment, but as merely exemplifications of some of several embodiments. Many other ramifications and variations are possible within the teachings of the various embodiments. For example, the shape and dimension of the function-enhancing portion could be changed, as may its orientation and location with respect to the enclosing member and pass-through wall section. The function-enhancing portion could be designed to provide any of a number of function enhancements, including but not limited to stopping the hinge, adding ability to hang something from the hinge, adding ability to decorate the hinge, or adding other variations of functional utility without departing from the scope of the embodiments. The shape and dimension of the pass-through wall section could also be changed. The enclosing member could have other dimensions and shapes, such as something other than strictly circular. The enclosing member could be made to attach to the hinge in some other way besides sliding over a hinge knuckle. For example, it could be made to snap onto the hinge. The illustrated embodiments of the hinge attachment discussed herein may be made of a variety of materials, including metals, plastics, ceramics, composites, and the like, without departing from the scope and intent of this disclosure. The hinge attachment could also be made of a mixture of two or more materials, and certain of the materials could be flexible, instead of rigid, also without departing from the scope of this disclosure.

Thus the scope should be determined by the appended claims and their legal equivalents, rather than the examples given.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A hinge attachment comprising:
a curved body including:
a first end and a second end at opposite ends of a length of the curved body defining an opening into a passage enclosed by an inner surface of the curved body, the inner surface adapted to fit around a knuckle of a hinge, the opening is wider than a thickness of a hinge plate attached to the knuckle,
a pass-through wall section of the curved body that includes a first thickness that is less than a size of a gap between the knuckle and an opposing hinge plate of the hinge, and
a function-enhancing section along the length of the curved body including a stop portion defined by a second thickness greater than the first thickness, wherein the second thickness is greater than the size of the gap between the knuckle and the opposing hinge plate of the hinge.

2. The hinge attachment of claim 1, wherein, when the hinge attachment is affixed to a hinge, the hinge plate may move freely along the length of the curved body from the first end to the stop portion.

3. The hinge attachment of claim 1, wherein the stop portion limits the range of travel of the opposing hinge plate to ninety degrees.

4. The hinge attachment of claim 1, wherein the stop portion limits the range of travel of the opposing hinge plate to forty-five degrees.

5. The hinge attachment of claim 1, wherein the stop portion limits the range of travel of the opposing hinge plate to an amount between thirty to sixty degrees.

6. The hinge attachment of claim 1, wherein the stop portion limits the range of travel of the opposing hinge plate to an amount between seventy-five to ninety degrees.

7. The hinge attachment of claim 1, wherein the stop portion limits the range of travel of the opposing hinge plate to an amount between one hundred twenty to one hundred fifty degrees.

8. The hinge attachment of claim 1, wherein the curved body is a unitary body.

9. A method of adding functionality to a hinge comprising the steps of:
providing a hinge attachment comprising a curved body including:
a first end and a second end at opposite ends of a length of the curved body defining an opening into a passage enclosed by an inner surface of the curved body, the inner surface adapted to fit around a knuckle of a hinge, the opening is wider than a thickness of a hinge plate attached to the knuckle,
a pass-through wall section of the curved body that includes a first thickness that is less than a size of a gap between the knuckle and an opposing hinge plate of the hinge, and
a function-enhancing section along the length of the curved body including a stop portion defined by a second thickness greater than the first thickness, wherein the second thickness is greater than the size of the gap between the knuckle and the opposing hinge plate of the hinge, and
mounting the hinge attachment to the hinge by aligning the opening with the hinge plate and sliding the hinge attachment over the knuckle;
wherein, when the hinge attachment is mounted on the hinge, the stop portion limits the range of travel of the opposing hinge plate to an open angle.

10. The hinge attachment of claim 9, wherein the open angle is one hundred eighty degrees.

11. The hinge attachment of claim 9, wherein the open angle is ninety degrees.

12. The hinge attachment of claim 9, wherein open angle is forty-five degrees.
